(19) United States
(12) Patent Application Publication
(10) Pub. No.: US 2022/0281644 A1
(43) Pub. Date: Sep. 8, 2022

(54) CONTAINER FOR DOSING A FLOWABLE SOLID

(71) Applicant: PepsiCo, Inc., Purchase, NY (US)

(72) Inventors: Joseph Thomas CLARKSON, Purchase, NY (US); Xavier CORTADELLAS, Miami Beach, FL (US); Renee HAMAOUI, Boca Raton, FL (US); Toby Richard David WINGFIELD, Crystal Lake, IL (US); Ronald Edward ONDREY, Bayonne, NJ (US); Charles Simon PARADISE, Brooklyn, NY (US); Camille Anna RUCKER, Paradise Valley, AZ (US)

(21) Appl. No.: 17/193,811

(22) Filed: Mar. 5, 2021

(51) Int. Cl. B65D 25/52; B65D 25/24; A23L 2/39; G01F 19/00

(52) U.S. Cl. CPC B65D 25/52; B65D 25/24; A23L 2/39; G01F 19/00; A23V 2002/00

(57) ABSTRACT

Some embodiments are directed to a container for dispensing a flowable solid (e.g., powder) that comprises an interior volume and a partition separating the interior volume into a storage volume and a passage. The passage may include a dosing chamber and a passage. The storage volume may be in direct communication with the dosing chamber. The storage volume may include a floor positioned above the dosing chamber. The outlet passage may extend from the dosing chamber to an outlet. The partition may extend below the floor of the storage volume such that the partition restricts the flow of the flowable solid from the storage volume when the container is at least partially inverted to dispense a dose of flowable solid each time the container is at least partially inverted. The container may consistently dispense equal doses of flowable solid regardless the amount of flowable solid remaining in the storage volume.

### BACKGROUND

The present disclosure relates to containers for storing and dispensing a flowable solid (e.g., a powder, granules, cereals, or oats). More specifically, the present disclosure relates to containers for dispensing consistent and accurate doses of a flowable solid.

### BRIEF SUMMARY

Some embodiments are directed to a container for dispensing a flowable solid comprising an interior volume and a partition separating the interior volume into a storage volume, a dosing chamber, and an outlet passage. The storage volume may be in direct communication with the dosing chamber and have a floor positioned above the dosing chamber. The outlet passage may extend from the dosing chamber to an outlet. The partition may extend below the floor of the storage volume such that the partition restricts the flow of the flowable solid from the storage volume when the container is at least partially inverted. The container may dispense a dose of flowable solid each time the container is at least partially inverted. Each dose may have an equal volume.

In any of the various embodiments discussed herein, each dose has a predetermined volume, which can be set at a volume between 0.1 mL and 250 mL. For example, a container for dispensing doses of electrolyte powder may have a predetermined dose volume set at a volume between 0.2 mL and 0.5 mL (e.g., 0.25 mL), a container for dispensing doses of hydration powder may have a predetermined dose volume set at a volume between 15 mL and 60 mL (e.g., 30 mL), and a container for dispensing doses of a cereal (e.g., oats) may have a predetermined dose volume set at a volume between 60 mL and 240 mL (e.g., 150 mL).

In any of the various embodiments discussed herein, the dosing chamber is sized to accommodate a single dose of flowable solids.

In any of the various embodiments discussed herein, a height of the outlet passage is at least three times a height of the dosing chamber.

In any of the various embodiments discussed herein, at least a portion of the interior volume has a return (e.g., forms a U-shape).

In any of the various embodiments discussed herein, flowable solid is disposed in the storage volume. In any of the various embodiments discussed herein, the flowable solid is a beverage concentrate.

In any of the various embodiments discussed herein the storage volume further comprises an opening for filling the storage volume. In any of the various embodiments discussed herein the opening is coaxial with the outlet.

In any of the various embodiments discussed herein, the container comprises a plug removably coupled to the container and configured to seal the opening.

In any of the various embodiments discussed herein, the container is entirely recyclable.

In any of the various embodiments discussed herein, the container is made of a single material.

In any of the various embodiments discussed herein, the container is made of high density polyethylene.

In any of the various embodiments discussed herein, the container comprises a base that defines the floor and a wall extending from the floor to a bottom of the dosing chamber.

In any of the various embodiments discussed herein, the outlet and the storage volume are each disposed above the dosing chamber.

Some embodiments are directed to a container for dispensing a flowable solid comprising a storage volume for housing the flowable solid, a lead-in passage, a dosing chamber, and an outlet. The storage volume may be defined at least in part by a partition within an interior volume of the container. The lead-in passage may be defined by the partition and a wall and be in direct communication with the storage volume. The dosing chamber may be disposed below the floor and be in direct communication with the lead-in passage. When the storage volume is filled with an amount of flowable solid between one dose and the capacity of the storage volume and when the container is in an upright position, a single dose of flowable solid may be disposed in the dosing chamber;

In any of the various embodiments discussed herein, when the container is in a tilted orientation, a partition separates the single dose from any remaining flowable solid. In any of the various embodiments discussed herein, when the container is in an inverted orientation, the container is configured to dispense only the single dose through the outlet.

In any of the various embodiments discussed herein, the dosing chamber may be configured to automatically receive another dose of flowable solid from the storage volume when the container returns to the upright orientation from the tilted orientation or the inverted orientation.

In any of the various embodiments discussed herein, the container may be in the tilted orientation when the container is rotated greater than 0 degrees and less than 115 degrees from the upright orientation. In any of the various embodiments discussed herein, the container may be in the inverted orientation when the container is rotated greater than 115 degrees and less than 180 degrees from the upright orientation.

In any of the various embodiments discussed herein, the container further comprises a passage configured to connect the outlet with the storage volume. In any of the various embodiments discussed herein, the passage comprises the lead-in passage, the dosing chamber, and a second passage. The second passage may extend from the dosing chamber to the outlet.

In any of the various embodiments discussed herein, at least a portion of the passage forms a U-shape.

In any of the various embodiments discussed herein, the container comprises an opening that is coaxial with the outlet to form a filling path extending through the second passage to the storage volume.

In any of the various embodiments discussed herein, the lead-in passage and the second passage each extend vertically.

### BRIEF DESCRIPTION OF THE FIGURES

The accompanying drawings, which are incorporated herein and form part of the specification, illustrate the present disclosure and, together with the description, further serve to explain the principles of the disclosure and to enable a person skill in the relevant art to make and use the invention.

FIG. 1 is a perspective view of a container according to some embodiments.

FIG. 2 is a top-down view of the container of FIG. 1.

FIG. 3 is a cross-sectional view of the container of FIG. 1 taken along line 3-3 of FIG. 2.

FIG. 4A is the cross-sectional view of FIG. 3 with powder in the container along with a drinking vessel.

FIG. 4B illustrates tilting of the container of FIG. 4A to separate a dose from the remainder of the powder.

FIG. 4C illustrates inversion of the container of FIG. 4A to dispense the dose shown in FIG. 4B into a drinking vessel.

FIG. 5 illustrates a flow chart for dispensing a dose of powder.

### DETAILED DESCRIPTION

Powders, such as beverage concentrates, sugar, etc., are often sold in bulk in large containers. Not only is it difficult to accurately remove a consistent amount of powder from these containers, doing so can be messy and slow. To accurately remove a dose of powder, a user may have to use a scoop to remove the powder. But the scoop may remove excess powder (requiring the user to level the powder to get an accurate amount or dose of the powder) or too little powder (requiring the user to scoop again to get an accurate amount or dose of the powder). Or to achieve an accurate dose in a single scoop, a user may have to scoop an excess amount, then use another tool or the user's fingers to level the powder. These scoops are often stored in the container itself and thus may become coated by powder or other substances.

Other dispensers may allow a user to dispense the powder without a scoop, but may provide little control over the amount dispensed. For example, containers with spouts (e.g., sugar dispensers) can dispense powder by pouring, but aside from estimating how much has been poured, there is no reliable way to control the amount of sugar dispensed, and the accuracy of the pour changes with the flow rate of the powder as the volume of powder remaining in the container decreases. Further, users may have to touch the spout to open and allow flow of powder.

Embodiments described herein overcome these and other challenges by providing—among other benefits—a container that consistently dispenses accurate doses of powder without measuring, regardless the amount of powder in the container and without moving mechanisms or separate components like scoops.

As shown throughout the figures, some embodiments are directed to a container for storing, dosing, and dispensing a flowable solid. A flowable solid is a volume of material that is formed of solid fragments or chunks of the material such that the volume of material can flow (e.g., when poured or sufficiently tilted). Examples include powder or granules (e.g., granulated sugar or beverage concentrate).

For example, the container may include an outlet and an interior volume. A partition may separate the interior volume into a storage volume and a passage. The passage may connect the storage volume to the outlet. The container may be used to dose a consistent volume of a powder from the storage volume, through the passage, and out the outlet without a holding area or any moving parts. The partition creates interior geometry of the container that allows for dosing a consistent volume of a powder. As described in more detail below, the container may measure and pour powder in one motion by inverting the container. The container also does not require moving parts, which can get stuck or make grinding noises during use. The container may use fewer materials and be easier to manufacture than systems with moving parts.

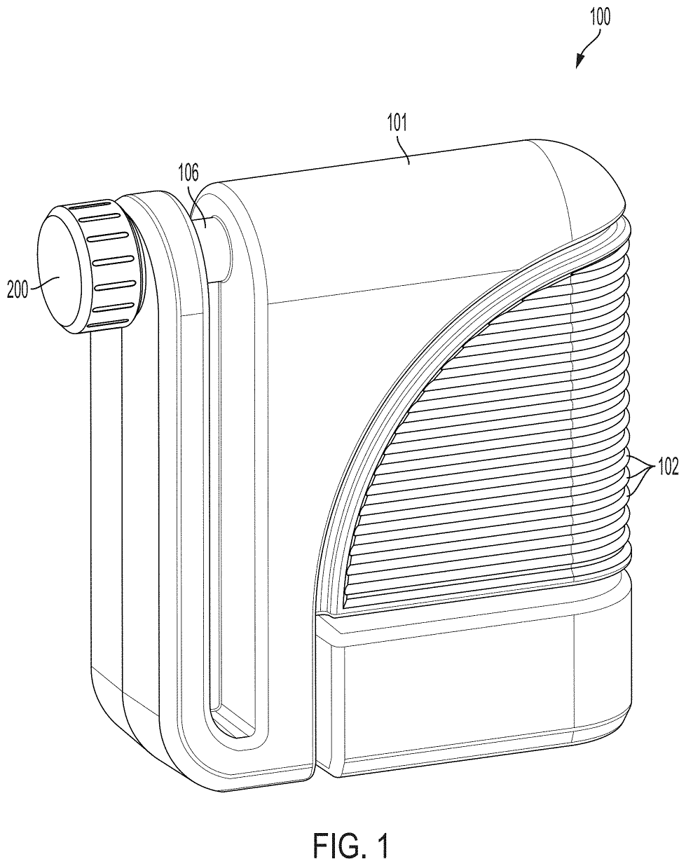

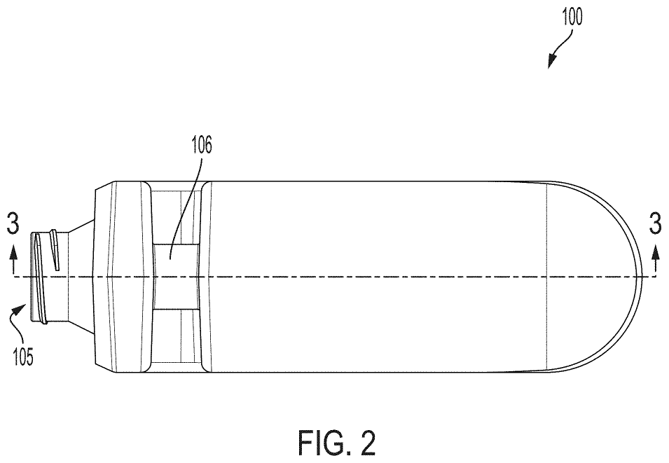

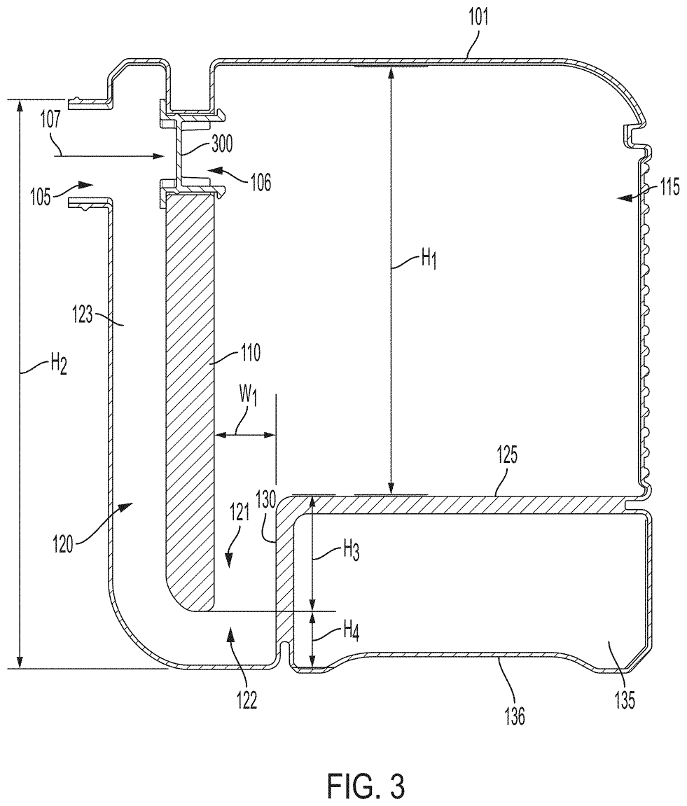

FIG. 1 illustrates container 100 for dispensing powder. Outer wall 101 of container 100 may contain an interior volume. Container 100 may include an outlet 105 that can be closed by cap 200. FIG. 2 illustrates a top-down view of container 100 with cap 200 removed from outlet 105. FIG. 3 illustrates a cross-sectional view of container 100 taken along line 3-3.

As illustrated in FIG. 3, container 100 may include partition 110 that separates an interior volume of container 100 into storage volume 115 and passage 120. Partition 110 may extend below floor 125 of storage volume 115 such that when container 100 is at least partially tilted or inverted, partition 110 restricts the flow of flowable solid 500 (e.g., a powder or granules) from storage volume 115 toward passage 120. In some embodiments, partition 110 restricts the flow of powder so that only one dose of powder is dispensed from container 100 each time container 100 is at least partially inverted.

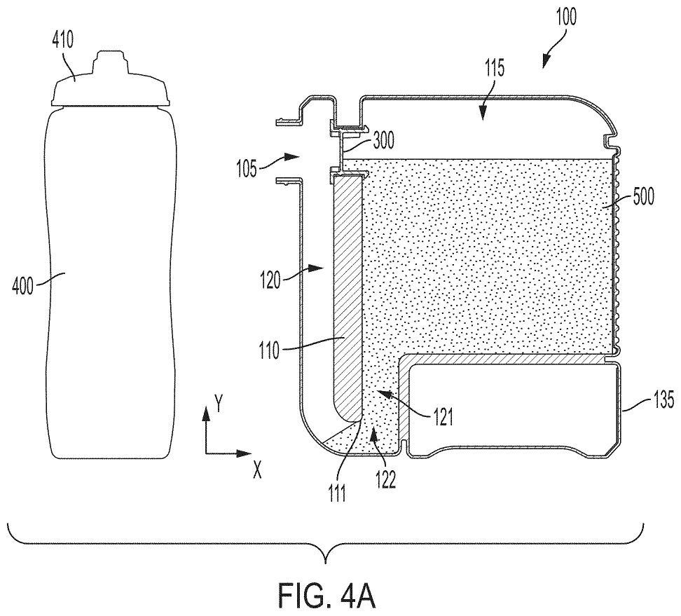

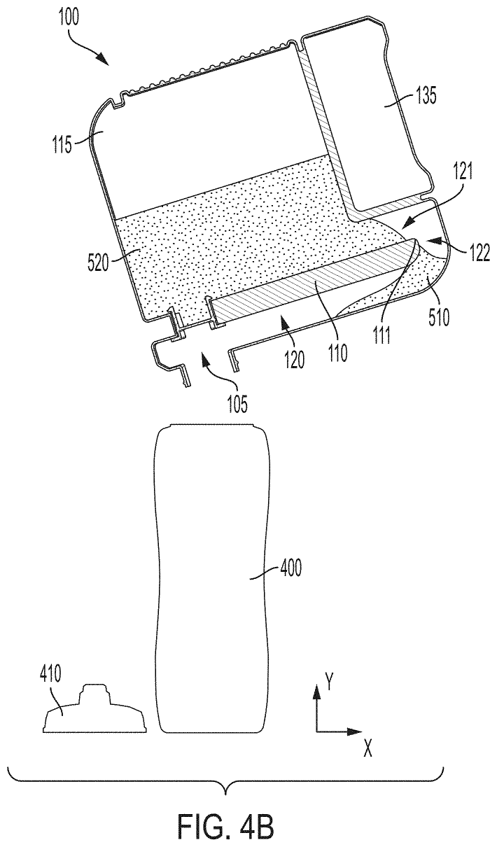

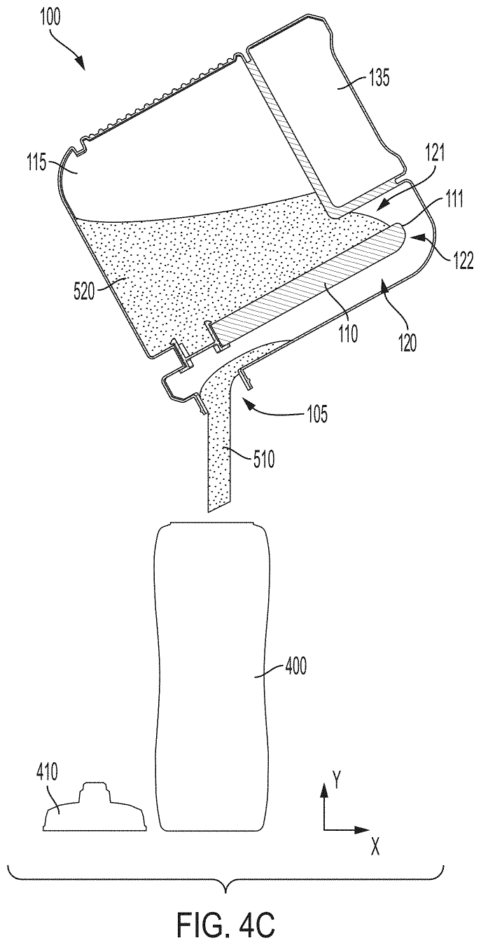

Storage volume 115 may be in communication with outlet 105 through passage 120. Storage volume 115 may be configured to store a powder or granules (e.g., flowable solid 500 shown in FIGS. 4A-4C). In some embodiments, storage volume 115 may have a capacity of about 50 mL to about 5 L. Some contents (e.g., spices, sugar, salt, beverage concentrates, hydrations powders, electrolyte powders, etc.) are generally used in low doses (about 0.1 mL to about 60 mL) and other contents (e.g., food products, cereals, or oats) are generally used in higher doses (about 60 mL to about 250 mL). And the capacity is storage volume 115 may be large enough to accommodate multiple doses. In some embodiments, storage volume 115 may have a capacity of about 50 mL to about 250 mL (e.g., about 100 mL to about 150 mL). In some embodiments, storage volume 115 may have a capacity of about 500 mL to about 1.5 L (e.g., about 500 mL to about 750 mL or about 750 mL to about 1 L). In some embodiments, storage volume 115 has a capacity of about 600 mL. In some embodiments, storage volume 115 may have a capacity of about 2 L to about 5 L (e.g., about 3 L to about 5 L or about 4 L to about 5 L). In some embodiments, storage volume 115 has a capacity of about 4.5 L.

In some embodiments, container 100 includes a base 135 that defines floor 125 of storage volume 115 and wall 130. Floor 125 may be perpendicular to wall 130 or may be at an oblique angle more relative to wall 130. Wall 130 may extend downward from floor 125 to a bottom of container 100. Base 135 may allow container 100 to stand upright and improve stability of the container when not in use. The height of base 135 provides a height differential between floor 125 of storage volume 115 and dosing chamber 122 of passage 120, which may also help control the flow of powder, as discussed in more detail below. In contrast to containers for dispensing liquid, which may use a “staging volume” before being dispensed, this height differential allows for an accurate dose of powder or granules (e.g., flowable solid 500) to be dispensed directly from storage volume 115. Base 135 may form an interior volume (e.g., it may be hollow), but the interior volume of base 135 is not in communication with storage volume 115 or passage 120. The interior volume of base 135 may be closed (e.g., by a bottom wall 136 as shown in the figures), or alternatively base 135 may be open (e.g., base 135 may not have a bottom wall 136). In some embodiments wall 130 extends vertically higher than the position of floor 125. For example, floor 125 may be positioned lower than shown relative to wall 130, and/or wall 130 may extend vertically higher than shown (e.g., floor 125 may be positioned at the base of bottom wall 136).

Container 100 may include passage 120 that connects storage volume 115 to outlet 105. As shown in FIG. 3, partition 110 may extend vertically into the interior volume such that at least a portion of passage 120 may forms a return such that dosing chamber 122 is positioned below both lead-in passage 121 and outlet passage 123. In some embodiments, at least a portion of passage 120 forms a U-shaped passage. Passage 120 may include three segments: lead-in passage 121, dosing chamber 122, and outlet passage 123. In some embodiments, partition 110 extends vertically between lead-in passage 121 and outlet passage 123. As illustrated in FIG. 3, lead-in passage 121 may be in direct communication with storage volume 115 and dosing chamber 122. Dosing chamber 122 may be in direct communication with lead-in passage 121 and outlet passage 123. Outlet passage 123 may be in direct communication with dosing chamber 122 and outlet 105. Lead-in passage 121, dosing chamber 122, and outlet passage 123 are each continuous portions of passage 120, as shown throughout the figures. In some embodiments, outlet passage 123 is parallel to lead-in passage 121 and perpendicular to dosing chamber 122. In some embodiments, outlet passage 123 at an angle less than 90 degrees (e.g., about 30 degrees, about 45 degrees, or about 60 degrees) relative to the dosing chamber 122.

Dosing chamber 122 is disposed entirely lower than floor 125. This position helps to break the flow of flowable solid 500 when container 100 is inverted as discussed below. In some embodiments, the bottom surface of partition 110 aligns with the top of dosing chamber 122.

Outlet passage 123 may have a height, H₂. In some embodiments, height, H₂, is greater than the height, H₁, of storage volume 115. In some embodiments, outlet passage 123 has a height, H₂, less than the height, H₁, of storage volume 115. In some embodiments, outlet passage 123 has a height, H₂, that is about 25% to about 50% greater than the height, H₁, of storage volume 115. Storage volume 115 may have a height, H₁, of about 50 mm to about 350 mm (e.g., about 75 mm to about 250 mm, about 100 mm to about 200 mm, or about 120 mm to about 130 mm). In some embodiments, storage volume 115 has a height, H₁, of about 125 mm. Outlet passage 123 may have a height, H₂, of about 150 mm to about 200 mm (e.g., about 165 mm to about 185 mm). In some embodiments, outlet passage 123 has a height, H₂, of about 175 mm.

In some embodiments, lead-in passage 121 may have a volume of about 20 mL to about 100 mL (e.g. about 10 mL to about 75 mL, or about 20 mL to about 50 mL). In some embodiments, lead-in passage 121 has a volume of about 26 mL.

In some embodiments, dosing chamber 122 may have a volume of about 15 mL to about 50 mL (e.g. about 10 mL to about 40 mL, or about 15 mL to about 25 mL). In some embodiments, dosing chamber 122 has a volume of about 17 mL.

The ratio between the volumes of lead-in passage 121 and dosing chamber 122 may allow for consistent and accurate dispensing of a single dose (e.g., serving size) of a powder, granules, oats, or cereal (e.g. flowable solid 500 as shown in FIGS. 4A-C). The volume of dosing chamber 122 and/or lead-in passage 121 may be altered to accommodate for different dosing sizes. For example, by decreasing the volume of dosing chamber 122 (e.g., by decreasing height H₄ or width of the dosing chamber) and/or lead-in passage 121 (e.g., by decreasing the width W₁ of the lead-in passage), dosing size decreases. Conversely, by increasing the volume of dosing chamber 122 and/or lead-in passage 121, the dosing size increases. In some embodiments, the dose size may be changed by modifying the size of dosing chamber 122 independent of lead-in passage 121. For example, dose size can be decreased by decreasing the width of dosing chamber 122 or can be increased by increasing the width of dosing chamber 122, independent of the size of lead-in passage 121.

For example, the ratio of the volume of lead-in passage 121 to the volume of dosing chamber 122 may be from about 2:1 to about 1:3 (e.g., from 1:1 to about 2:3). In some embodiments, the ratio of the volume of lead-in passage 121 to the volume of dosing chamber 122 is about 2:3. In some embodiments, the ratio between height H₃ of lead-in passage 121 and the width W₁ of lead-in passage 121 is at least 3:2 (e.g., at least to about 4:2). Further, base 135 may have a height equal to the sum of a height, H₃, of lead-in passage 121 and a height, H₄, of dosing chamber 122, as illustrated in FIGS. 1 and 3-4C. In some embodiments, this allows container 100 to stand upright and maintain stability while not in use. In some embodiments, H₃ is between about 25 millimeters and 50 millimeters (e.g., between about 30 millimeters and 40 millimeters). In some embodiments, H₃ is about 35 millimeters. In some embodiments, H₄ is between about 5 millimeters and 25 millimeters (e.g., between about 10 millimeters and 20 millimeters or between about 10 millimeters and 15 millimeters). In some embodiments, H₄ is about 12 millimeters.

In some embodiments, lead-in passage 121 has a volume of about 20 mL to about 50 mL and a height of about 30 millimeters to about 40 millimeters, dosing chamber 122 has a volume of about 15 mL to about 25 mL and a height of about 10 millimeters to about 15 millimeters. In some embodiments, dosing chamber 122 is positioned about 30 millimeters to about 40 millimeters below floor 125.

Outlet passage 123 may extend between dosing chamber 122 and outlet 105. As shown in FIG. 3, the height, H₂, of outlet passage 123 may be greater than the height, H₁, of storage volume 115. In some embodiments, the height, H₂, of outlet passage 123 is less than the height of storage volume 115 but is greater than the height, H₄, of dosing chamber 122 such that outlet 105 is higher than dosing chamber 122. In some embodiments, outlet passage 123 may have a height, H₂, that is at least 3 times greater (e.g., at least 4 times greater or at least 5 times greater) than a height, H₄, of the dosing chamber 122. This ensures that flowable solid 500 is not dispensed from container 100 before a dose (e.g., dose 510) has been separated from the flowable solid in container 100, which in turn ensures consistent and accurate dispensing of a single dose or serving size.

Outlet 105 may be formed in outlet passage 123 such that, when container 100 is moved from an upright orientation (shown in FIG. 4A) to an inverted orientation (shown in FIG. 4C), powder is dispensed through outlet 105. Outlet 105 may be positioned at a height that is higher than the top of dosing chamber 122. In some embodiments, outlet 105 is positioned at a height above the height of floor 125 of storage volume 115. If outlet 105 is too low, the flowable solid may dispense before a full dose has separated (see FIGS. 4B and 4C), which may reduce the accuracy of the dose. In some embodiments, outlet 105 is sealed with a removable cap (e.g., cap 200).

Container 100 may include a filling passageway (e.g., opening 106) for filling storage volume 115. Opening 106 may be positioned to form an inlet into storage volume 115 such that storage volume 115 can be directly filled (e.g., without filling through passage 120). Alternatively, container 100 may not have opening 106 and may be filled through passage 120. In some embodiments, outlet 105 is coaxial with opening 106 such that storage volume 115 may be filled with powder through outlet 105, outlet passage 123, and opening 106 (e.g., along the path indicated by arrow 107 in FIG. 3). This may eliminate the need for an external filling passageway such that opening 106 is the only exterior opening. Opening 106 may be sealed using plug 300. In some embodiments, plug 300 is removable to allow refilling of container 100. In some embodiments, plug 300 is coupled to container 100 after filling and plug 300 is not removable. In some embodiments, plug 300 is couples to container 100 via a snap fit.

Container 100 may include various surface features on outer wall 101. For example, as illustrated in FIG. 1, outer wall 101 may include a plurality of ribs 102. Ribs 102 may aid in gripping container 100.

Container 100 may be a blow-molded container or may be constructed from injection molded parts. Container 100 may be made of various materials, including one or more of a thermoplastic (e.g., high density polyethylene (HDPE), acrylonitrile butadiene styrene (ABS)), a copolyester, or a bioplastic. Container 100 may be made of a single material (e.g., HDPE). This allows for container 100 to be recycled in a single recycling stream without any breakdown of component parts. In some embodiments, container 100 is fully recyclable. In some embodiments, container 100, cap 200, and plug 300 are all made of the same material. In some embodiments, container 100, cap 200, and plug 300 are all made of HDPE.

Container 100 may be a blow molded container or may be constructed from injection molded parts such that container 100 forms a unitary structure. Container 100 may be filled with flowable solid 500 by inserting a filling device along the path shown by arrow 107 (e.g., through outlet 105, outlet passage 123, and opening 106). After filling, plug 300 maybe inserted into opening 106 to seal opening 106. Container 100 may be sealed with cap 200. Flowable solid 500 may be used to create a beverage by mixing a dose with water. For example, flowable solid 500 may include flavorings, electrolytes, nutritional supplements, or a combination of these. In some embodiments, flowable solid 500 is a beverage concentrate. In some embodiments, each dose of flowable solid 500 has an equal volume. Some contents (e.g., spices, sugar, salt, beverage concentrates, hydrations powders, electrolyte powders, etc.) are generally used in low doses (about 0.1 mL to about 60 mL) and other contents (e.g., food products, cereals, or oats) are generally used in higher doses (about 60 mL to about 250 mL). Container 100 may be used to dispense equal dose. Each dose may have a predetermined volume, which can be set at a volume between 0.1 mL and 250 mL. For example, a container for electrolyte powders may dispense a dose having a predetermined volume from about 0.1 mL to about 0.5 mL, a container for a beverage concentrate may dispense a dose having a predetermined volume from about 1 mL to about 30 mL, a container for a hydration powder may dispense a dose having a predetermined volume from about 15 mL to about 60 mL, and a container for dispensing a food product (e.g., cereals or oats) may dispense a dose having a predetermined volume from about 60 mL to about 250 mL.

In some embodiments, each dose of flowable solid 500 has a predetermined volume from about 0.1 mL to about 250 mL (e.g., about 0.1 mL to about 0.5 mL, about 1 mL to about 5 mL, about 2 mL to about 3 mL, about 15 mL to about 60 mL, about 25 mL to about 35 mL, or about 60 mL to about 250 mL). In some embodiments, each dose of flowable solid 500 has a volume of about 2.5 mL. In some embodiments, each dose of flowable solid 500 has a volume of about 30 mL.

For convenience container 100 is discussed in terms of dispensing powder or granules as flowable solid 500, but it should be understood that container 100 may be filled with other products that can be dispensed in a similar way. For example, container 100 could be filled with any type of flowable solid (e.g., a granulated or powdered product) that would benefit from dispensing accurate doses (e.g., beverage concentrates, hydration powders, electrolyte powders, sugar, salt, spices, etc.). In some embodiments, flowable-solid food products (e.g., cereals or oats) with a larger particle size than powder or granules may be dispensed from container 100. For example, oats may be dosed for making single-serve oatmeal.

Container 100 may dispense an accurate and consistent dose of powder by simply inverting container 100 in the direction of outlet 105. The amount of powder dosed is independent of the volume of powder remaining in the container (assuming at least enough for one full dose remains) and of the speed at which a user inverts the container. FIGS. 4A-4C illustrate the process of dispensing a powder. FIG. 4A illustrates container 100 in an upright orientation, drinking vessel 400, and drinking vessel closure 410. As illustrated in FIG. 4A, storage volume 115 is partially filled with flowable solid 500, and because floor 125 of storage volume 115 is higher than lead-in passage 121 and dosing chamber 122, some flowable solid 500 has fallen into lead-in passage 121 and dosing chamber 122.

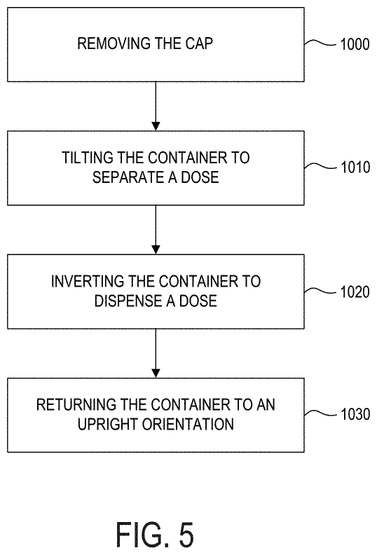

FIG. 5 is a flow chart illustrating how equal doses of powder are dispensed from container 100 by rotating container 100, and will be discussed with reference to FIGS. 4A-4C. At step 1000, a user removes cap 200. At step 1010, a user moves container 100 from an upright orientation (FIG. 4A) to a tilted orientation (FIG. 4B), which separates dose 510 (previously within dosing chamber 122) of flowable solid 500 from remainder 520. Dose 510 separates from remainder 520 at corner 111 between dosing chamber 122 and lead-in passage 121. Because flowable solids can pile without slumping to varying degrees (i.e., the flowable solid's angle of repose) they do not flow as readily as a liquid. Thus flowable solid 500 has an angle of repose such that flowable solid 500 readily separates at corner 111 without appreciable variation in dose amount regardless of differences in the speed at which container 100 is rotated. However, depending on the material being dispensed, the angle of repose will vary. In some embodiments, the flowable solid has an angle of repose of at least 30 degrees. A liquid, in contrast, could flow more easily and quickly, such that the flow of the dispensed liquid does not separate and the amount of dispensed liquid could be widely varied depending on the speed at which container 100 is rotated.

At step 1020, a user moves container 100 to an inverted orientation (FIG. 4C) to dispense dose 510 of flowable solid 500. Partition 110 holds remainder 520 and prevents it from entering passage 120 in this orientation. As container 100 is rotated from the tilted orientation to the inverted orientation, dose 510 of flowable solid 500 moves along outlet passage 123 to outlet 105 and exits container 100 via outlet 105. As illustrated in FIG. 4C, dose 510 of flowable solid 500 may be dispensed into vessel 400. Vessel 400 may be any kind of vessel configured to receive flowable solid 500 (e.g., a beverage container, a cooler, a food container, a bowl, or any other suitable food or beverage container). The dose 510 of flowable solid 500 may be mixed with water in vessel 400 to make a beverage. Because of the structure of container 100 and relative positions of storage volume 115, lead-in passage 121, dosing chamber 122, and outlet passage 123, each time the container is rotated from the upright position to the inverted position, only one dose of powder (e.g., dose 510 of flowable solid 500) is dispensed. To dispense another dose of powder, a user simply rotates the container back to the upright orientation (step 1030), which causes a dose 510 to separate from remainder 520 of flowable solid 500. After separating, dose 510 falls into dosing chamber 122, and then repeats the process of rotating the container to the tilted position (step 1010) and then to the inverted position (step 1020). Each time container 100 is moved back to the upright position, a single dose (e.g., dose 510) of flowable solid 500 is disposed in the dosing chamber. By repeating this process, a user can consistently dispense equal doses of powder each time the process is repeated, until all of the powder has been dispensed from container 100. Steps 1010 to 1030 can be repeated until storage volume 115 is empty. In other words, a user can dispense equal doses of powder as long as storage volume 115 is filled with an amount of flowable solid 500 between one dose and the capacity of storage volume 115.

In some embodiments, container 100 is in the titled orientation when it is rotated greater than 0 degrees from the upright position and less than about 115 degrees. In some embodiments, container 100 is in the inverted orientation when it is rotated greater than about 115 degrees and less than about 180 degrees from the upright orientation.

As used herein, the terms “above,” “below,” “higher,” “upright,” “tilted,” “inverted,” and the like are intended to assist in understanding of embodiments of the disclosure with reference to the accompanying drawings with respect to the orientation of the container as shown, and are not intended to be limiting to the scope of the disclosure or to limit the disclosure scope to the embodiments depicted in the Figures. The directional terms are used for convenience of description and it is understood that a container may be positioned in any of various orientations.

As used herein, the terms “equal volume” or “equal dose” include tolerances for minor variations from the actual dose size. For example, “equal volume” or “equal dose” may include tolerances of ±10% from the actual dose or volume.

When a value is used herein as an end-point of a range, the disclosure should be understood to include the specific value or end-point referred to. As used herein, the term “about” includes ±10%.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The breadth and scope of the present disclosure should not be limited by any of the above-described exemplary embodiments, but should be defined only in accordance with the claims and their equivalents.

1. A container for dispensing a flowable solid, the container comprising:
an interior volume;
a partition separating the interior volume into a storage volume and an outlet passage;
a wall; and
a dosing chamber defined at least partially by the wall and the partition,
wherein the storage volume is in direct communication with the dosing chamber,
wherein the outlet passage extends from the dosing chamber to an outlet,
wherein the partition and the wall restrict the flow of the flowable solid from the storage volume when the container is at least partially inverted to dispense a dose of flowable solid each time the container is at least partially inverted, and
wherein each dose has an equal volume.

2. The container of claim 1, wherein each dose has a volume from 0.1 mL to 250 mL.

3. The container of claim 1, wherein the dosing chamber is sized to accommodate a single dose of flowable solid.

4. The container of claim 1, wherein a height of the outlet passage is at least three times a height of the dosing chamber.

5. The container of claim 1, wherein at least a portion of the interior volume forms a U-shape.

6. The container of claim 1, further comprising the flowable solid disposed in the storage volume, wherein the flowable solid is a beverage concentrate.

7. The container of claim 1, wherein the storage volume further comprises a floor, and wherein the wall extends up from the floor.

8. The container of claim 7, further comprising a closure configured to reversibly seal the outlet.

9. The container of claim 1, wherein the container is entirely recyclable.

10. The container of claim 9, wherein the container is made of a single material.

11. The container of claim 10, wherein the container is made of high density polyethylene.

12. The container of claim 1, further comprising a base that defines the floor and the wall, the wall extending from the floor to a bottom of the dosing chamber.

13. The container of claim 1, wherein the outlet and the storage volume are each disposed above the dosing chamber.

14. A container for dispensing a flowable solid, the container comprising:
a storage volume for housing the flowable solid, the storage volume defined at least in part by a partition within an interior volume of the container;
a lead-in passage defined by the partition and a wall, wherein the lead-in passage is in direct communication with the storage volume;
a dosing chamber disposed below the lead-in passage and in direct communication with the lead-in passage; and
an outlet;
wherein when the storage volume is filled with an amount of flowable solid between one dose and the capacity of the storage volume and when the container is in an upright position, a single dose of flowable solid is disposed in the dosing chamber;
wherein when the container is in a tilted orientation, a partition separates the single dose from any remaining flowable solid; and
wherein when the container is in an inverted orientation, the container is configured to dispense only the single dose through the outlet.

15. The container of claim 14, wherein the dosing chamber is configured to automatically receive another dose of flowable solid from the storage volume when the container returns to the upright orientation from the tilted orientation or the inverted orientation.

16. The container of claim 14, wherein the container is in the tilted orientation when the container is rotated greater than 0 degrees and less than 115 degrees from the upright orientation, and wherein the container is in the inverted orientation when the container is rotated greater than 115 degrees and less than 180 degrees from the upright orientation.

17. The container of claim 14, further comprising a passage configured to connect the outlet with the storage volume, wherein the passage comprises:
the lead-in passage;
the dosing chamber; and
a second passage extending from the dosing chamber to the outlet.

18. The container of claim 17, wherein at least a portion of the passage forms a U-shape.

19. The container of claim 17, further comprising a closure configured to reversibly seal the outlet.

20. The container of claim 17, wherein the lead-in passage and the second passage each extend vertically.
